(19) United States
(12) Patent Application Publication
(10) Pub. No.: US 2015/0051924 A1
(43) Pub. Date: Feb. 19, 2015

(54) METHOD FOR DETERMINING AND MAINTAINING ELIGIBILITY FOR INVESTORS IN A CROP REINSURANCE COMPANY

(71) Applicants: Billy Rose, Grimes, IA (US); Craig Mouchka, West Des Moines, IA (US)

(72) Inventors: Billy Rose, Grimes, IA (US); Craig Mouchka, West Des Moines, IA (US)

(21) Appl. No.: 13/968,739

(22) Filed: Aug. 16, 2013

(51) Int. Cl. G06Q 40/08

(52) U.S. Cl. CPC G06Q 40/08; G06Q 40/04
USPC 705/4

(57) ABSTRACT

An investment opportunity is designed to tie eligibility of investment to a series of relationships. The series of relationships requires, first, that an approved insurance provider enter a contractual agreement with a reinsurer and, second, that an agent of the approved insurance provider sell an insurance policy to an individual for crop insurance and places that policy with the approved insurance provider that has a contractual agreement with the reinsurer. Once this occurs, the agent and the purchaser of the crop insurance policy are each eligible investors in the reinsurance company. They are each allowed to invest up to some maximum amount wherein that maximum is dictated by the number acres insured under the crop insurance policy.

### FIELD OF INVENTION

The present invention pertains to investment opportunities in general and, more specifically, to creating an investment opportunity for agents and policy holders which opportunity comports with section III(a)(4) of the Standard Reinsurance Agreement's limitation on compensation that Approved Insurance Providers may pay to persons involved in the direct sale and service of eligible crop insurance contracts.

### BACKGROUND

Reinsurance is insurance that is purchased by an insurance company (the “ceding company” or “cedant” or “cedent” under the arrangement) from one or more other insurance companies (the “reinsurer”) as a means of risk management. The ceding company and the reinsurer enter into a reinsurance agreement which details the conditions upon which the reinsurer would pay a share of the claims incurred by the ceding company. The reinsurer is paid a “reinsurance premium” by the ceding company, which issues insurance policies to its own policyholders or the reinsurer participates in the profit or loss of the ceding company net of ceding commission paid by the reinsurer to the ceding company.

There are two basic methods of reinsurance. The first is a method of facultative reinsurance which is insurance negotiated separately for each insurance contract that is to be reinsured. Often facultative reinsurance is purchased by the ceding company to cover risks that are not covered or that are insufficiently covered by their reinsurance treaties or for amounts in excess of the reinsurance treaties. Treaty reinsurance is the second method. In this method, the reinsurer and the ceding company negotiate a reinsurance contract which requires the reinsurer to cover a specific share of all the insurance policies issued by the ceding company as required by the contract. There are two main types of treaty reinsurance: proportional where the reinsurer's share of the risk is defined for each separate policy, or non-proportional where the reinsurer's liability is based on the aggregate claims incurred by the ceding office.

Many insurance companies have a reinsurance program to reduce their exposure to loss by passing part of the risk to loss to a reinsurer. With reinsurance, the insurer can issue policies with higher limits than would otherwise be allowed, and so are able to take on more risk because some of that risk is now transferred to the reinsurer.

The insurance company may be motivated by arbitrage in purchasing reinsurance coverage at a lower rate than they charge the insured for the underlying risk, whatever the class of insurance. In general, the reinsurer may be able to cover the risk at a lower premium than the insurer because the reinsurer may have some intrinsic cost advantage due to economies of scale or they may be less strictly regulated or work within more favorable tax regimes. Reinsurers can often have more diverse portfolios and be able to hedge their risks.

Agents selling crop insurance and their insureds are faced each year with the sales and purchase (or renewal) of crop insurance. Crop insurance is under tight federal regulations with regard to offering multi-peril crop insurance covering hail, excessive rain and drought in a combined package. Sometimes, additional risks such as insect or bacteria-related diseases are also offered. The problem with the multi-peril crop insurance is the possibility of a large scale event which may result in losses that the insurer cannot cover. To make this class of insurance, the perils are often bundled together in a single policy, called a multi-peril crop insurance (MPCI) policy which is offered by a government insurer with partially government-subsidized premiums. The Federal Crop Insurance Corporation (FCIC) manages the multi-peril insurance program offered by the federal government. The Risk Management Agency (RMA) is an agency active in calculating the premiums based on individual risk factors since 1981 and also sets the rules and regulations by which agencies and agents operate.

The USDA (United States Department of Agriculture) is authorized to offer basically free catastrophic (CAT) coverage to producers who grow an insurable crop. This subsidized multi-peril federal insurance program is available to most farmers covering more than 100 different crops, although not every crop is covered in every locale. And then, for a premium, farmers can buy additional coverage beyond the CAT level. Federal crop insurance is sold and serviced through private insurance companies where a portion of the premium, and the expenses of the private companies are subsidized. The FCIC reinsures these private companies by absorbing some of the losses of the program when indemnities exceed total premiums. Several revenue insurance products are available on major crops as a form of additional coverage.

As of the 2011 reinsurance year, limitations on agent compensation related to crop insurance were implemented by the RMA. These limitations forbid what are known as “schemes or devices” used to circumvent the agent compensation limits. Specifically, a scheme or device is defined as making a payment or providing a benefit that meets the requirements of agent compensation but not reporting it as such. For example, any payment to an agent which is an inducement for the agent to move their book of business from one Approved Insurance Provider (AIP) to another is considered agent compensation. AIP is an insurance company approved by the RMA to sell federal crop insurance and/or state insurance departments to sell private hail and named peril insurance products. Under this rubric, a payment by default is agent compensation unless it meets a specified exception. For example, under these rules, if an Approved Insurance Provider's agent compensation expense is more than 80% of the FCIC administrative and operating (A&O) reimbursement for a particular state, then any excess payments will likely constitute a “scheme or device”.

Therefore, in order for an agent to invest in a reinsurance company that has a business relationship with the Approved Insurance Provider, there are specific indicia that need to be present. The basic premise is that the agency's capital should not be at risk to preserve the agent's ability to continue to service their policyholders and there should be no incentives to violate their conflict of interest rules. Specifically, the risks reinsured should not be limited to agents/agencies who are owners of the reinsurance company, no agent should review or be involved in the claims process, all reinsurance terms and agreements, such as a Quota Share Agreement, employed between the ceding company and the reinsurer, should be normal and customary and cannot be limited to or in any way specifically related to the agents/agencies own books of business. Conditions of the transaction of a purchase of reinsurance by the ceding company should be “normal and customary” with the reinsurance being an arm's length transaction.

With all these rules and regulations, the ability for insurance agents and their policy holders to invest in a reinsurance company that reinsures federally subsidized crop insurance is effectively blocked from the usual avenues by which reinsurers are able to conduct business. The present invention offers a method by which insurance agents and their policy holders may invest in a reinsurance company that reinsures federally subsidized crop insurance.

### SUMMARY OF THE PRESENT INVENTION

The present invention allows participation by investment in a reinsurance company by a group of insureds and their agents, all within the guidelines forbidding unreported AIP agent compensation and guidelines forbidding policyholder rebating. Specifically, for crop insurance, this method allows a reinsurance company to offer to agents of and farmer policy holders of policies offered by an AIP an opportunity to invest in a reinsurance company which company reinsures crop failure and works with the AIP provider that has a quota share agreement with that reinsurance company.

The reinsurance company would reinsure crop damage insurance (although it would not be restricted only to reinsuring crop insurance) via a Quota Share agreement with the AIP. Under a Quota Share Agreement, cash is paid by the AIP to the reinsurance company for the protection share that the reinsurance takes on. The share may be 10% of the risk, or less or more. The present invention employs a Quota Share agreement and, although not described herein, there may be situations where a stop loss agreement (i.e. pays a fixed percentage to the reinsurance company regardless of losses) might be used.

The opportunity for the agent and/or for its insureds to participate in the reinsurance company as investor/owners in accordance with the present invention relies on a series of relationships. Specifically, there must be an agreement between the AIP and a reinsurance company; an agent must be an agent appointed by that AIP; and that agent must sell at least one crop insurance policy to a farmer who's crop insurance policy is placed with that AIP. Either the farmer who buys the crop insurance policy, or the agent appointed by the AIP who sold the crop insurance policy, or both, may participate in the reinsurance company as investor/owners.

### BRIEF DESCRIPTION OF THE DRAWINGS

A better understanding of the present invention will be had upon reference to the following description in conjunction with the accompanying drawings, Wherein:

FIG. 1 shows a flow chart depicting an exemplary set of actions required by a computer program or a computer-facilitated method of the present invention; and

FIG. 2 shows a high level flow chart showing the order of events facilitated by a computer program or computer-facilitated method of the present invention.

### DETAILED DESCRIPTION OF THE PRESENT INVENTION

Described more specifically, the present invention requires that an agreement, typically a Quota Share agreement, must be in place between the AIP and the reinsurer so that the AIP is referred to as the “Contracted AIP”. Then, agents and/or their insureds will be eligible to invest in the reinsurance company under specific circumstances. An “Eligible Agent” is an appointed agent of the Contracted AIP who has sold a policy to a farmer for crop insurance. And, if a farmer buys a crop insurance policy from an Eligible Agent and the Eligible Agent places that crop insurance policy with the Contracted AIP, then that farmer becomes an “Eligible Policy Holder”. Where there exists a Contracted AIP, an Eligible Agent and at least one Eligible Policy Holder then the Eligible Agent and/or the Eligible Policy Holder will individually be allowed to invest in the reinsurance company.

The maximum possible level of investment for an Eligible Agent is dictated (directly related to) by the number of acres insured under all of the policies of the Contracted AIP that the Agent has sold. The maximum possible level of investment for an Eligible Policy Holder is dictated by (directly related to) the number of acres insured under the policy he purchased from the Eligible Agent. In other words, the investment opportunity in the reinsurance company for a policy holder of the Contracted AIP is directly a function of a) a sale of that policy to the policy holder by an Eligible Agent having an agent relationship with the Contracted AIP, b) the number of acres the policy holder has insured with the Contracted AIP through that policy, c) and the existence of a Quota Share Agreement between the Contracted AIP and the reinsurance company.

One way of determining the maximum level of investment allowed for an Eligible Agent is a function of the average premium per acre paid for the insurance. For an Eligible Agent with a $1 million dollar book of business on crop insurance (i.e. premiums paid for crop insurance) the number of acres eligible would be 25,000 ($1 million/$40). In this scenario, each acre would be deemed worth 2 units where 1 unit of investment would be offered to the Eligible Policy Holder and the other would be offered to the Eligible Agent for equal prices. In one embodiment the reinsurance company pools all such investments not by agency but by state to form a cell or cells, although it would be conceivable that cells created on the basis of different geography may also be employed. Returns would be calculated by cell and returned/distributed in accordance with the number of units owned.

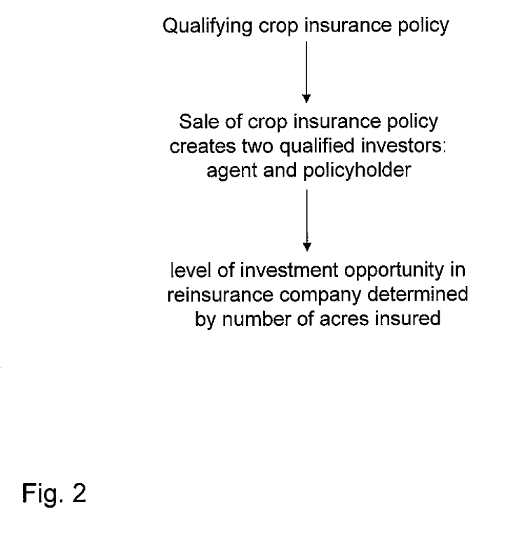

In an example, the payout of returns is limited to a particular set of conditions. In this example, the AIP is the ceding company and has entered into a Quota Share Agreement with a Reinsurance Company. (See FIG. 2) The risk that is reinsured by the reinsurance company cannot be specific to an agency and therefore the agreement with the ceding company needs to be a quota share agreement or a stop loss agreement or other arrangement where specific risk is based on the AIP's entire book of business. The cede is preferably based on a percentage of the insured risk. Dividends (i.e. distributions by the reinsurance company) are triggered by the occurrence of three things: 1) the AIP must be profitable on a net basis; 2) the reinsurance company must be profitable relative to its agreement with the AIP; 3) the state (group, or cell or cells) must be profitable on a net basis and, thereafter, Reinsurance Company will distribute profits based on the cell's profits and will distribute profits equally on a per unit basis. Although not required, it is expected that risk may be controlled or addressed by investment in other reinsurance companies.

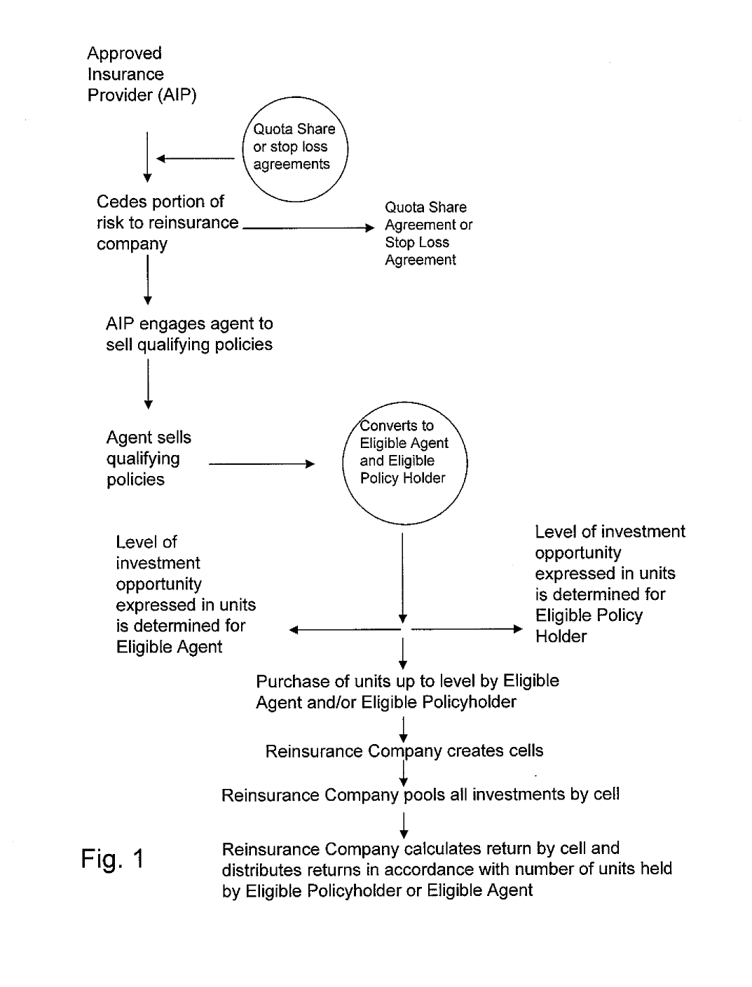

The method of the present invention may be facilitated by the use of one or more computers programmed to perform one or more functions. Specifically, referring now to FIG. 1, one or more computers may be programmed to determine whether an appropriate agreement is in place between an AIP and the reinsurance company and whether the agent in question is appointed by the AIP to sell qualifying policies. If so, the agent is designated as “eligible”. Programming then determines whether a policy sold by an Eligible Agent is a qualifying policy and, if so, the purchaser of the policy is designated as “eligible”. Based on the status of eligibility, the program then applies an algorithm to determine the level of investment available to each or either or both of the Eligible Agent and the Eligible Policy Holder. The algorithm may, for example, take into account the total number of acres insured by policies sold by the Eligible Agent in order to determine agent's maximum investment level, but may take into account only the acres insured by the Eligible Policy Holder to determine the policy holder's maximum investment level.

The same or another computer or computers may create cells based on at least one criteria. The said at least one criteria may include geographic territory, or may be an aggregate of policies insuring a particular number of acres. The investments are then pooled by cell and the programming calculates dividend per unit by cell and may, subsequently, calculate a return to at least one of an Eligible Agent and/or an Eligible Policy Holder.

In order for a dividend to be paid out, the method preferably requires a set of criteria to be met. Often criteria are directed to determining whether the parties are profitable before paying out. The same computer or another computer or computers may be programmed to determine whether the AIP is profitable on a net basis, and whether the reinsurance company is profitable relative to its agreement with the AIP. A determination is facilitated by the computer program to determine whether a cell is profitable on a net basis. These determinations may be made before or after the dividends are calculated in accordance with the preceding paragraph. If all three aspects show profitability, then the returns calculated as described in the preceding paragraph can be paid out; if not, then no payments are allocated.

The present invention has been described using various terms in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A method for creating an investment opportunity comprising offering units of investment in a reinsurance company to a pool of eligible investors wherein said pool of eligible investors is restricted to a plurality of investors comprising at least one selected from a group comprising: at least one appointed insurance agent of an approved insurance provider, and at least one holder of a first insurance policy provided by said approved insurance provider and sold to said holder by the at least one appointed insurance agent; and said approved insurance provider has ceded a portion of its risk to said reinsurance company by contract.

2. The method of claim 1 wherein said contract comprises a quota share agreement.

3. The method of claim 1 wherein said first insurance policy is a crop insurance policy.

4. The method of claim 3 wherein said crop insurance policy insures a specific number of acres and said investment opportunity is offered to each of said eligible investors on the basis of the number of acres insured by the first insurance policy held by that eligible investor.

5. An investment opportunity comprising:
a) a plurality of units of investment in a reinsurance company;
b) an approved insurer;
c) a pool of eligible investors comprising at least one insurance agent having an agency agreement with said approved insurer and a sale by said at least one insurance agent to at least one purchaser of at least one crop insurance policy insuring a number of acres said at least one crop insurance policy offered by said approved insurer;
d) wherein each of said pool of eligible investors is eligible to purchase a specified number of said units of investment based on the number of acres insured by said crop insurance policy.

6. The investment opportunity of claim 5 wherein a return on said investment opportunity is determined in accordance with the return on a geographic area in which the number of acres is located.

7. The investment opportunity of claim 5 wherein said pool of eligible investors includes at least one purchaser of a crop insurance policy from said at least one appointed insurance agent making said purchaser eligible to purchase a specified number of said units of investment based on the number of acres insured by said crop insurance policy.

8. The investment opportunity of claim 5 wherein said at least one appointed insurance agent is eligible to purchase a specified number of said units of investment based on the number of acres insured by all said crop insurance policies sold by said insurance agent to said at least one purchaser of a crop insurance policy.

9. The investment opportunity of claim 5 wherein said approved insurer and said reinsurance company are contractually related.

10. The investment opportunity of claim 9 wherein said contract is a quota share contract.

11. The investment opportunity of claim 5 wherein said specified number of said units is priced in accordance with an average price of insurance premium per acre insured.

12. The investment opportunity of claim 11 wherein each of said at least one eligible investor is eligible to purchase the same number of units at the same price per unit based on the same crop insurance policy.

13. An investment opportunity comprising a plurality of units of investment in a reinsurance company; a crop insurance policy sold by an agent of an approved insurance provider which approved insurance provider is contractually related to a reinsurance company; a number of acres insured under said crop insurance policy; wherein a portion of said plurality of units is sold to at least one of the agent of the approved insurance provider or an owner of the crop insurance policy.

14. An investment opportunity comprising a total number of units of investment said total number of units comprising a plurality of groups of units each said group of units directly related to a number and location of acres insured by a crop insurance policy sold by an agent of an approved insurance provider, said approved insurance provider contractually related to a reinsurance company by a quota share agreement wherein said total number of units is converted to a distribution of profits as determined by a computer program comprising means for:
a) recording and facilitating verification of the existence of said contract between the approved insurance provider and the reinsurance company;
b) verifying an agent relationship between the agent and the approved insurance provider;
c) verifying purchase of a crop insurance policy from said agent and a number and location of a plurality of acres insured by said crop insurance policy;
d) determining whether the approved insurance company is profitable on a net basis;
e) determining whether the reinsurance company is profitable relative to its agreement with the approved insurance provider;
f) calculating the profitability of a geographically limited cell in which said plurality of acres is present;
g) allocating profits of the reinsurance company contributed by said geographically limited cell to the plurality of groups of units associated with the number of acres located in said cell.

15. The investment opportunity of claim 14 wherein conversion of said units to a distribution of profits is further determined by said computer program comprising means to:
a) calculate the profitability of said geographically limited cell on a net basis and
b) allocate an equal amount of net profit of the geographically limited cell to each of said number of units associated with that geographically limited cell.

16. An investment opportunity comprising:
a) an approved insurance provider;
b) a pool of eligible investors comprising at least one insurance agent having an agency agreement with said approved insurer and at least one purchaser of at least one crop insurance policy insuring a number of acres said at least one crop insurance policy offered by said approved insurer and sold by said at least one insurance agent;
c) wherein for each such insurance policy, each of said insurance agent and said purchaser of said crop insurance policy is eligible to purchase a specified number of said units of investment based on the number of acres insured by said crop insurance policy.

17. The investment opportunity of claim 16 wherein a return on said investment opportunity is determined in accordance with the return on a geographic area in which the number of acres is located wherein distribution of profits is made in accordance with said number of units and determined by a computer program comprising means for:
a) recording and facilitating verification of the existence of a contract between the approved insurance provider and the reinsurance company;
b) verifying an agent relationship between the agent and the approved insurance provider;
c) verifying purchase of said crop insurance policy from said agent and the number and location of said acres insured by said crop insurance policy;
d) determining whether the approved insurance company is profitable on a net basis;
e) determining whether the reinsurance company is profitable relative to its agreement with the approved insurance provider;
f) calculating the profitability of the geographic area in which said plurality of acres is present;
g) allocating profits of the reinsurance company contributed by said geographic area to the plurality of units associated with the number of acres located in said area allocating an equal amount of net profit of the geographic area to each of said number of units associated with that geographic area.

18. A computer-facilitated method for creation and administration of a qualified investment in a reinsurance company by eligible investors, said method comprising at least one computer wherein said at least one or more computers are programmed to perform one or more steps comprising:
a) determining whether a Quota Share or stop loss (Stop Loss) agreement is in force between an AIP and said reinsurance company wherein said AIP cedes a portion of its risk to the reinsurance company;
b) determining whether an agent is appointed by the AIP to sell a qualifying policy and, if so, designating said agent as an eligible agent;
c) determining whether a policy sold by an eligible agent to a policyholder is a qualifying policy and, if so, designating the policyholder as an eligible policyholder.

19. A computer-facilitated method for creation and administration of a qualified investment in a reinsurance company by eligible investors, said method comprising at least one computer wherein said at least one or more computers are programmed to perform one or more steps comprising creating at least one cell based on at least one criteria, pooling investments by cell, calculating dividend per unit by cell, and calculating a dividend to at least one of an eligible agent and an eligible policyholder.

20. The method of claim 19 wherein at least one of said at least one computer is programmed to determine whether a policy is a qualifying policy sold by an eligible agent and, if so, designates the policyholder as an eligible policyholder.

21. The method of claim 19 wherein one of said at least one computer is programmed to determine whether an agent is an eligible agent be ascertaining the existence of a valid agreement between the AIP and the agent.

22. A computer-facilitated method for creation and administration of a qualified investment in a reinsurance company by eligible investors including creating cells and calculating dividends to eligible investors in that cell, said method comprising at least one computer wherein said at least one or more computers are programmed to perform one or more steps comprising:
a) determining profitability of an AIP, profitability of a reinsurance company relative to an agreement between the reinsurance company and the AIP, and profitability of a cell on a net basis;
b) where the AIP, reinsurance company, and cell are determined to be profitable, assigning dividends to each eligible investor in said cell.
